(19) United States
(12) Patent Application Publication
(10) Pub. No.: US 2004/0241337 A1
(43) Pub. Date: Dec. 2, 2004

(54) Coloring agent addition system

(75) Inventors: Slawomir Nachilo, Hyannis, MA (US); Paul J. Shanahan, Brewster, MA (US)

Correspondence Address: HOFFMANN & BARON, LLP, 6900 JERICHO TURNPIKE, SYOSSET, NY, 11791, US

(73) Assignee: EAC Operations, Inc.

(21) Appl. No.: 10/856,258

(22) Filed: May 28, 2004

Related U.S. Application Data
(60) Provisional application No. 60/475,146, filed on Jun. 2, 2003.

(51) Int. Cl. B05C 11/02; B05B 17/00

(52) U.S. Cl. 427/444; 118/56; 118/303

(57) ABSTRACT

A coloring agent addition system which generally includes a processing module having an in-feed conveyor for receiving and processing a raw material and a coloring unit connected to the in-feed conveyor for adding a coloring agent to the raw material. The coloring unit is driven by the processing module to deliver the coloring agent depending on operation of the processing module. The coloring unit includes a motor that is in fluid communication with a hydraulic fluid line of a processing module motor, whereby the processing module motor is connected in series to the coloring unit motor to drive the coloring unit.

### CROSS-REFERENCE TO RELATED APPLICATIONS

This application claims the benefit of U.S. Provisional Application No. 60/475,146, filed on Jun. 2, 2003.

### FIELD OF THE INVENTION

The present invention relates generally to coloring agent addition systems and, more particularly, to a system for adding a dry coloring agent to a landscape product processing stream. The present invention has broader application to all such machinery that reduce particle size or classify particle size of incoming materials and addresses the need for environmentally sound and low-cost coloring of materials to meet market demands.

### BACKGROUND OF THE INVENTION

Landscape product manufacturers, and other related industries, use horizontal bulk material grinders, shredders, and screening devices (“the processing equipment”) to produce large volumes of material such as garden mulch and compost. Such processing equipment provide particle size reduction and particle size classification. For certain types of landscape products, a coloring agent is added to enhance the product's appearance and aesthetic value.

The most common approach for adding color to these materials is by spraying a liquid coloring agent on the material, either at the raw material inlet or at the raw material outlet of the processing equipment. Because the material passes below on a conveyor belt, application of a liquid coloring agent at the processing equipment outlet results in an over application of color to the material on top of the belt and an under application of color to the material underneath. Other drawbacks of liquid coloring agents are their relatively high costs in comparison to dry coloring agents and the fact that liquid coloring agents cannot be used in freezing winter climates and require water flows up to 20 gallons per minute for diluting concentrated liquid coloring agent and spraying onto the raw material.

Dry coloring agents are available on the market, however, primitive practices are currently required to mix it with raw material. These practices include dumping sacks of dry coloring agent on large piles of raw material and re-mixing the entire pile to distribute the coloring agent, or filling a bulldozer bucket with dry coloring agent and dumping it on the pile, followed by more mixing. In either case, these practices result in significant amounts of fugitive dust, health hazards to employees, and increased costs from additional material handling. Further, these practices do not achieve an acceptable consistency of coloring necessary for maximum market value of the finished product.

Application of either a liquid or a dry coloring agent at the processing equipment inlet would allow better mixing of the coloring agent and the raw material with a minimum of additional material handling. However, it is difficult to achieve consistent coloring when waste material flow rates fluctuate during normal processing, due to plugs, excessive moisture, and other normal variations in material consistency.

Accordingly, it would be desirable to provide a low-cost coloring unit for installation on any horizontal processing equipment inlet conveyor that can efficiently and automatically respond to changes in raw material feed rates while taking advantage of the processing equipment's natural mixing operation to apply the coloring agent concurrently and proportionally.

### SUMMARY OF THE INVENTION

The present invention is a coloring agent addition system generally including a processing module having an in-feed conveyor for receiving and processing a raw material and a coloring unit connected to the in-feed conveyor for adding a coloring agent to the raw material. The coloring unit is driven by the processing module to deliver the coloring agent depending on operation of the processing module. Preferably, the coloring agent is delivered at a rate dependent on a rate of operation of the processing module.

In a preferred embodiment, the processing module includes a hydraulic motor for driving the in-feed conveyor and the coloring unit includes a hydraulic motor for delivering the coloring agent to the raw material. The coloring unit motor is in fluid communication with a hydraulic fluid line of the processing module motor, whereby the processing module motor is connected in series to the coloring unit motor to drive the coloring unit.

Preferably, the coloring unit includes a hopper for containing an amount of coloring agent, a motor and a rotating metering shaft. The hopper has a bottom with an opening and the rotating metering shaft is disposed adjacent the hopper bottom opening. The metering shaft is driven by the motor to deliver the coloring agent through the hopper bottom opening. The rotating metering shaft may include at least one groove for receiving and intermittently delivering a fixed amount of coloring agent through the hopper bottom opening as the metering shaft rotates.

The hopper may further include an inclined side wall and a removable wear plate made from a low-friction material disposed on an interior of the side wall. Also, the coloring unit may further include a rotating agitator driven by the motor for tumbling the color agent within the hopper.

The present invention further involves a method for adding a coloring agent to a raw material stream. The method generally includes the steps of receiving the raw material on an in-feed conveyor of a processing module, delivering the coloring agent to the raw material upstream of the processing module at a rate dependent on a rate of operation of the processing module and mixing the raw material and the coloring agent in the processing module.

In a preferred embodiment, the rate of operation of the processing module is communicated to a coloring unit, which delivers the coloring agent to the raw material. Preferably, hydraulic fluid is routed from a processing module motor to a coloring unit motor, wherein the rate of operation of the coloring unit motor is dependent on the rate of operation of the processing module motor. The processing module motor drives the in-feed conveyor of the processing module and the coloring unit motor drives the delivery of the coloring agent to the raw material.

The present invention may take the form of a coloring unit that can be mounted on any conventional horizontal processing equipment inlet conveyor. The unit is interconnected with the existing processing equipment hydraulic system and interlocked to deliver the proper amount of coloring agent in proportion to the processing equipment raw material in-feed rate, thus assuring consistent, high-quality, low-cost colored material for market. By interconnecting in series with the existing hydraulic system, the dry coloring unit stops whenever the processing equipment stops, thus minimizing spillage and excessive loss of coloring agent typical for prior art inlet coloring systems.

The present invention utilizes a hopper, specially designed to deliver coloring agent without bridging or plugging, an agitator to deliver coloring agent to a metering shaft, and a low-cost aluminum extruded grooved metering shaft to meter coloring agent onto the waste in-feed conveyor. By stopping and starting the dry coloring unit's hydraulic drive motor in response to the main processing equipment operation, exact control is achieved with a minimum amount of waste or spillage.

The present invention is inexpensive to construct and operate because of its parasitic use of the existing hydraulic system of the processing equipment (e.g., grinder or shredder) and solves all of the problems associated with the current practices. Even transportation cost of finished product to market is minimized by completely eliminating the use of water in liquid coloring systems.

The preferred embodiments of the coloring agent addition system as well as other objects, features and advantages of this invention, will be apparent from the following detailed description, which is to be read in conjunction with the accompanying drawing.

### BRIEF DESCRIPTION OF THE DRAWING

FIG. 1 is a schematic drawing of the coloring agent addition system formed in accordance with the present invention.

### DETAILED DESCRIPTION OF THE PREFERRED EMBODIMENTS

The present invention improves upon the current art of applying liquid and dry coloring agents to large volumes of raw landscape material to enhance the marketability of processed landscape products such as landscape mulch and other products. Such landscape raw material may include lawn clippings, tree branches and other yard wastes. It has become increasingly more common for residential communities to have separate municipal yard waste collection for delivery to recycling facilities, which in turn convert the yard waste to valuable landscape products. During processing, however, it is often desirable to provide an aesthetically pleasing color to the landscape product. The present invention provides a simple yet innovative method for metering and controlling dry coloring agents onto the in-feed conveyor of a recycling facility's raw material processing equipment. Existing technology offers either liquid systems, that are more expensive and more difficult to control, or primitive dry application procedures that are inefficient, dangerous, and unhealthy.

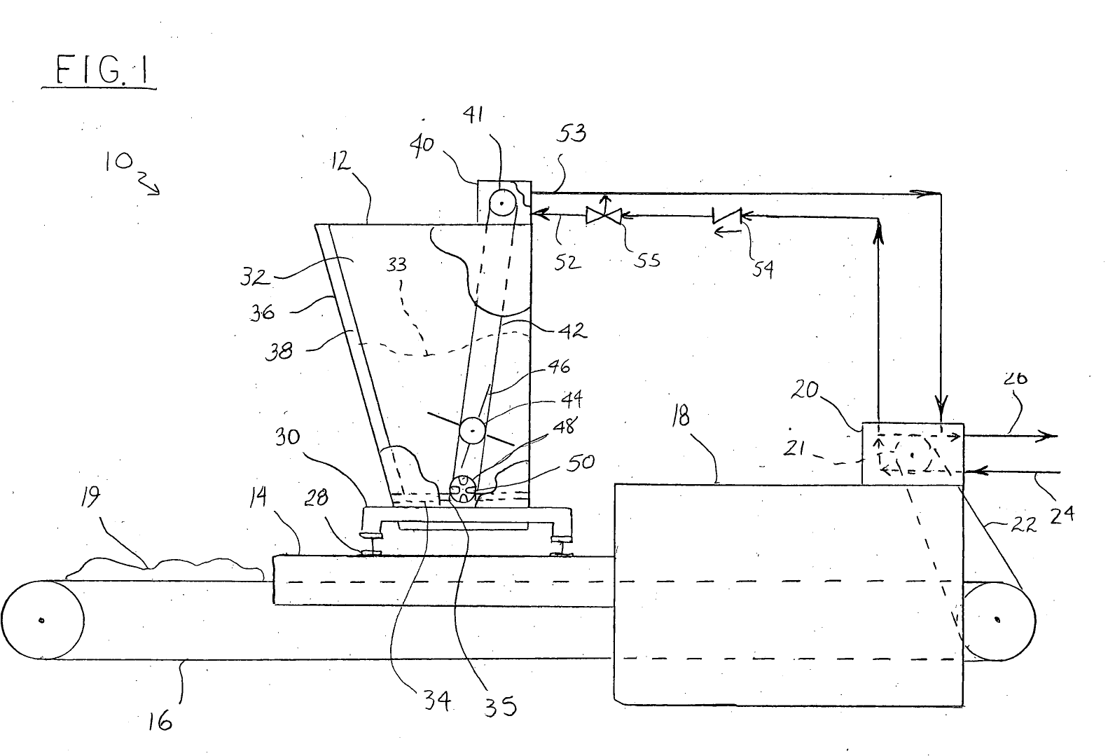

FIG. 1 is a schematic diagram showing the design features of the coloring agent addition system 10 of the present invention. The system 10 generally includes a dry coloring unit 12 mounted on the side rails 14 of an in-feed conveyor 16 of a processing unit 18. As discussed above, the processing unit 18 includes processing equipment, such as a horizontal grinder, shredder, mixer or screening device, for mixing and/or reducing the particle size of the incoming raw material 19. The processing unit 18 further includes a motor 20 for simultaneously driving both the processing equipment and the in-feed conveyor 16. For example, the in-feed conveyor 16 may be driven by the processing unit motor 20 via a sprocket 21 and a belt or chain 22.

The system 10 shown in FIG. 1 and described herein below is a hydraulic system, wherein the processing unit motor 20 is a hydraulic motor connected to a hydraulic fluid supply line 24 and a hydraulic fluid return line 26. However, it is conceivable that the system of the present invention can be electrically driven. In such case, the hydraulic fluid supply line 24 and the hydraulic fluid return line 26 would not be needed.

The coloring unit 12 may be mounted to the side walls 14 of the conveyor 16 using four to six adjustable mounting feet 28. Preferably, a breaker bar 30 is provided to stiffen the mounting structure of the unit 12 and protect the unit from damage by passing raw material. The dry coloring unit 12 includes a dry coloring unit hopper 32, which is constructed preferably of ¼″ steel plate and is designed to hold up to 1,000 pounds of a dry coloring agent 33, normally available in standard packages. The hopper 32 includes a bottom 34 having an opening 35 through which the dry coloring agent 33 is gravity-fed and applied to the incoming raw material 19. An inclined side 36 of the main hopper 32 is preferably provided with a removable wear plate 38 made of a suitable low-friction material, such as polyethylene plastic, to facilitate the downward flow of the coloring agent 33. The wear plate 36 can be secured to the inclined side 36 of the hopper 32 by mounting bolts that are countersunk to provide a smooth sliding surface for the coloring agent inside the main hopper.

The dry coloring unit 12 is further provided with a motor 40, which drives a sprocket 41 and chain 42. The hopper chain 42 drives an agitator 44, which may include blades or fins 46, for tumbling the dry coloring material within the main hopper 32. This tumbling action eliminates bridging of the dry coloring agent and regulates feed to a coloring agent metering shaft 48 located adjacent the opening 35 of the hopper bottom 35 and which is also driven by the hopper chain 42. The coloring agent metering shaft 48 is a specially designed low-cost aluminum extruded grooved shaft, which is adapted especially for consistent delivery of dry coloring agent. The grooves 50 of the shaft 48 hold a fixed amount of dry coloring agent to be delivered through the opening 35 of the hopper bottom 34. The delivery rate of the coloring agent metering shaft 48 can be varied by varying the speed of the motor 40.

As mentioned above, in a preferred embodiment, the system 10 of the present invention is hydraulically driven. Accordingly, the hopper motor 40 is a hydraulic motor having a hydraulic fluid inlet 52 and a hydraulic fluid return 53. The hydraulic fluid inlet 52 and the hydraulic fluid return 53 of the hopper motor 40 are fluidly connected to the existing hydraulic system of the processing unit 18. For example, hydraulic fluid from the return line of the processing unit's hydraulic motor 20 can be rerouted first through a check valve 54, to protect against reverse operation of the processing equipment, and further through a control valve 55 to the hopper hydraulic motor 40.

Preferably, the rate of operation of the processing module motor 20 determines the rate of operation of the hopper motor 40. However, the control valve 55 can be manually adjustable to provide varying speeds to the hydraulic hopper motor 40 for different types of coloring needs and products. Hydraulic fluid not passing through the control valve 55 is bypassed, along with fluid leaving the hydraulic hopper motor 40 to the main processing equipment hydraulic fluid return line 26.

In operation, as the hydraulic motor system 20 of the raw material processing unit 18 is activated to feed raw material 19 along the in-feed conveyor 16, hydraulic fluid from the processing equipment is supplied to the hydraulic hopper motor 40 to activate the coloring agent addition unit 12. The hopper chain 42 connected to the motor 40 in turn drives the agitator 44 and the coloring agent metering shaft 48 to intermittently deposit a fixed amount of dry coloring agent 33 through the bottom opening 35 of the hopper 32 onto the raw material passing below the hopper on the in-feed conveyor 16. The combined raw material 19 and coloring agent 33 is then fed to the processing equipment of the processing unit 18 where it is mixed thoroughly to provide a uniformly colored finished landscape product. If for any reason the raw material in-feed conveyor 16 is stopped by the processing unit motor 20, the hydraulic hopper motor 40 is also automatically stopped since its hydraulic fluid supply is tied to the hydraulic line of the processing unit. This prevents the coloring agent addition system of the present invention from continuing to operate if there is a stoppage of raw material flow.

By connecting the hopper motor 40 in series with the processing equipment motor 20, the hopper motor operates only when the processing equipment motor operates. This arrangement provides positive shut-off in the event of processing equipment stoppage. Moreover, in the preferred embodiment, the feed rate of the dry coloring agent 33 through the hopper 32 varies proportionally with the speed of the raw material in-feed rate, both of which is determined by the processing equipment motor 20. Thus, the present invention improves upon problems with current art related to feeding too much or too little coloring agent when surges or plugs of raw material occur, as they do frequently in normal operation.

Although the preferred embodiments of the present invention have been described with reference to the accompanying drawing, it is to be understood that the invention is not limited to those precise embodiments, and that other changes and modifications may be made by one skilled in the art without departing from the scope or spirit of the invention.

What is claimed is:

1. A coloring agent addition system comprising:
a processing module having an in-feed conveyor for receiving and processing a raw material; and
a coloring unit connected to said in-feed conveyor for adding a coloring agent to the raw material, said coloring unit being driven by said processing module to deliver the coloring agent depending on operation of said processing module.

2. A coloring agent addition system as defined in claim 1, wherein said coloring unit is driven by said processing module to deliver the coloring agent at a rate dependent on a rate of operation of said processing module.

3. A coloring agent addition system as defined in claim 1, wherein said processing module includes a motor for driving said in-feed conveyor and said coloring unit includes a motor for delivering the coloring agent to the raw material, said processing module motor communicating with said coloring unit motor to drive said coloring unit.

4. A coloring agent addition system as defined in claim 3, wherein said processing module motor and said coloring unit motor are hydraulic motors, said coloring unit motor being in fluid communication with a hydraulic fluid line of said processing module motor.

5. A coloring agent addition system as defined in claim 4, wherein said coloring unit motor is fluidly connected in series with said processing module motor.

6. A coloring agent addition system as defined in claim 1, wherein said coloring unit comprises:
a hopper for containing an amount of coloring agent, said hopper having a bottom with an opening for delivering the coloring agent therethrough;
a motor; and
a rotating metering shaft disposed adjacent said hopper bottom opening, said metering shaft being driven by said motor to deliver the coloring agent through said hopper bottom opening.

7. A coloring agent addition system as defined in claim 6, wherein said hopper includes an inclined side wall and a removable wear plate made from a low-friction material disposed on an interior of said side wall.

8. A coloring agent addition system as defined in claim 6, wherein said coloring unit further comprises a rotating agitator driven by said motor for tumbling the coloring agent within said hopper.

9. A coloring agent addition system as defined in claim 6, wherein said rotating metering shaft includes at least one groove for receiving and intermittently delivering a fixed amount of coloring agent through said hopper bottom opening as said metering shaft rotates.

10. A coloring unit for adding a coloring agent to a raw material stream being fed into a processing module, the coloring unit comprising a motor adapted for communication with a motor of the processing module for delivering the coloring agent depending on operation of the processing module.

11. A coloring unit as defined in claim 10, wherein said coloring unit motor is adapted for communication with the processing module motor for delivering the coloring agent at a rate dependent on a rate of operation of the processing module.

12. A coloring unit as defined in claim 10, wherein said coloring unit is adapted for mounting on an in-feed conveyor of the processing module.

13. A coloring unit as defined in claim 10, wherein said coloring unit motor is a hydraulic motor adapted to be in fluid communication with a hydraulic fluid line of the processing module motor.

14. A coloring unit as defined in claim 10, further comprising:
a hopper for containing an amount of coloring agent, said hopper having a bottom with an opening for delivering the coloring agent therethrough; and
a rotating metering shaft disposed adjacent said hopper bottom opening, said metering shaft being driven by said coloring unit motor to deliver the coloring agent through said hopper bottom opening.

15. A coloring unit as defined in claim 14, wherein said hopper includes an inclined side wall and a removable wear plate made from a low-friction material disposed on an interior of said side wall.

16. A coloring unit as defined in claim 14, wherein said coloring unit further comprises a rotating agitator driven by said motor for tumbling the coloring agent within said hopper.

17. A coloring unit as defined in claim 14, wherein said rotating metering shaft includes at least one groove for receiving and intermittently delivering a fixed amount of coloring agent through said hopper bottom opening as said metering shaft rotates.

18. A method for adding a coloring agent to a raw material stream comprising the steps of:
receiving the raw material on an in-feed conveyor of a processing module;
delivering the coloring agent to the raw material upstream of the processing module depending on operation of the processing module; and
mixing the raw material and the coloring agent in the processing module.

19. A method for adding a coloring agent to a raw material stream as defined in claim 18, wherein the coloring agent is delivered to the raw material at a rate dependent on a rate of operation of the processing module.

20. A method for adding a coloring agent to a raw material stream as defined in claim 19, further comprising the step of communicating the rate of operation of the processing module to a coloring unit, the coloring unit delivering the coloring agent to the raw material.

21. A method for adding a coloring agent to a raw material stream as defined in claim 19, further comprising the step of routing hydraulic fluid from a processing module motor to a coloring unit motor, the processing module motor driving the in-feed conveyor of the processing module and the coloring unit motor driving the delivery of the coloring agent to the raw material, wherein the rate of operation of the coloring unit motor is dependent on the rate of operation of the processing module motor.

22. A method for adding a coloring agent to a raw material stream as defined in claim 18, wherein the step of delivering the coloring agent to the raw material comprises the step of intermittently delivering a fixed amount of coloring agent to the raw material.
